(19) United States
(12) Patent Application Publication
(10) Pub. No.: US 2026/0181098 A1
(43) Pub. Date: Jun. 25, 2026

(54) MANAGEMENT DEVICE THAT MANAGES IMAGE FORMING APPARATUS

(71) Applicant: KYOCERA Document Solutions Inc., Osaka (JP)

(72) Inventor: Archer CASIO, Osaka (JP)

(73) Assignee: KYOCERA Document Solutions Inc., Osaka (JP)

(21) Appl. No.: 19/410,272

(22) Filed: Dec. 5, 2025

(30) Foreign Application Priority Data
Dec. 19, 2024 (JP) 2024-224507

(51) Int. Cl. H04N 1/44; H04N 1/00

(52) U.S. Cl. CPC H04N 1/4426; H04N 1/00079; H04N 1/00344; H04N 1/4433; H04N 2201/0094

(57) ABSTRACT

A management device includes an input device that receives an input of first information indicating a type of an optional function of an image forming apparatus, second information for issuing a license key for the optional function, third information indicating an address of the image forming apparatus, and fourth information for logging in to the image forming apparatus, a requester that transmits an instruction to issue the license key, by transmitting the second information to a license key issuing source that issues the license key for the optional function of the type indicated by the first information, and a transmitter that logs in to the image forming apparatus at the address indicated by the third information, by transmitting the fourth information, and transmits the license key, received from the license key issuing source in response to the instruction of the requester, to the image forming apparatus.

### INCORPORATION BY REFERENCE

This application claims priority to Japanese Patent Application No. 2024-224507 filed on Dec. 19, 2024, the entire contents of which are incorporated by reference herein.

### BACKGROUND

The present disclosure relates to a management device configured to manage a plurality of image forming apparatuses through a network.

Some of existing image forming apparatuses, such as a multifunction peripheral, are incorporated with optional functions, for example a card authentication kit (software that enables personal authentication with a card) and an internet fax kit (software that enables fax transmission through the internet).

Some of such optional functions require registration of a license key in the image forming apparatus, in order to make the function operate normally. The license key can be obtained, for example, through making access to a designated website (e.g., website being run by the provider of the card authentication kit), and inputting required information (e.g., serial number) to the website.

### SUMMARY

The disclosure proposes further improvement of the foregoing technique.

In an aspect, the disclosure provides a management device configured to manage a plurality of image forming apparatuses through a network. The management device includes a communication device, an input device, a requester, and a transmitter. The communication device makes communication with outside, through the network. The input device receives an input of first information indicating a type of an optional function provided in the image forming apparatus, second information necessary for issuance of a license key for the optional function, third information indicating an address of the image forming apparatus, and fourth information necessary for logging in to the image forming apparatus. The requester transmits an instruction requesting to issue the license key, by transmitting the second information via the communication device, to a predetermined license key issuing source that issues the license key for the optional function of the type indicated by the first information. The transmitter logs in to the image forming apparatus corresponding to the address indicated by the third information, by transmitting the fourth information via the communication device, and transmits the license key, received from the license key issuing source in response to the instruction of the requester, to the image forming apparatus.

### BRIEF DESCRIPTION OF THE DRAWINGS

FIG. 1 is schematic diagram showing an entirety of an information processing system, including a management device according to an embodiment of the disclosure;

FIG. 2 is a functional block diagram schematically showing an essential internal configuration of the management device according to a first embodiment;

FIG. 3A presents an example of a list including first to fourth information, received by an input device;

FIG. 3B presents an example of a list showing a specific example of each information shown in FIG. 3A;

FIG. 4 presents an example of information stored in a license information storage region;

FIG. 5 is a flowchart showing an example of a process related to registration of a license key, executed by the management device;

FIG. 6 is a functional block diagram schematically showing an essential internal configuration of the management device according to a second embodiment; and

FIG. 7 is a functional block diagram schematically showing an essential internal configuration of the management device according to a third embodiment.

### DETAILED DESCRIPTION

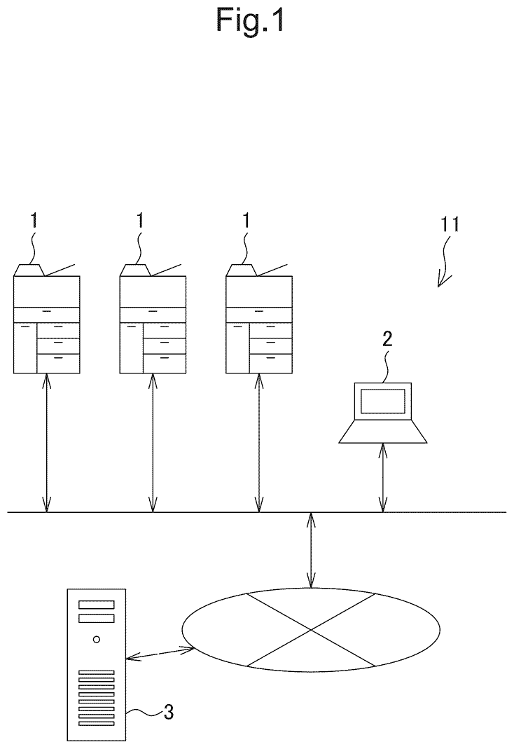

FIG. 1 is schematic diagram showing an entirety of an information processing system, including a management device according to an embodiment of the disclosure.

The information processing system 11 according to the embodiment includes a plurality of image forming apparatuses 1, the management device 2, and a license key issuing source 3, which are located on a network such as the internet. The image forming apparatus 1 is a multifunction peripheral having a plurality of functions, such as copying, printing, scanning, and facsimile transmission.

The management device 2 is for example a computer, and manages the image forming apparatus 1 through the network. The management device 2 is capable of managing a plurality of image forming apparatuses 1. The license key issuing source 3 issues a license key for an optional function of the image forming apparatus 1 (e.g., card authentication kit). The license key issuing source 3 is, for example, a server.

When the license key issued by the license key issuing source 3 is registered in the image forming apparatus 1, the optional function of the image forming apparatus 1 corresponding to the license key operates normally.

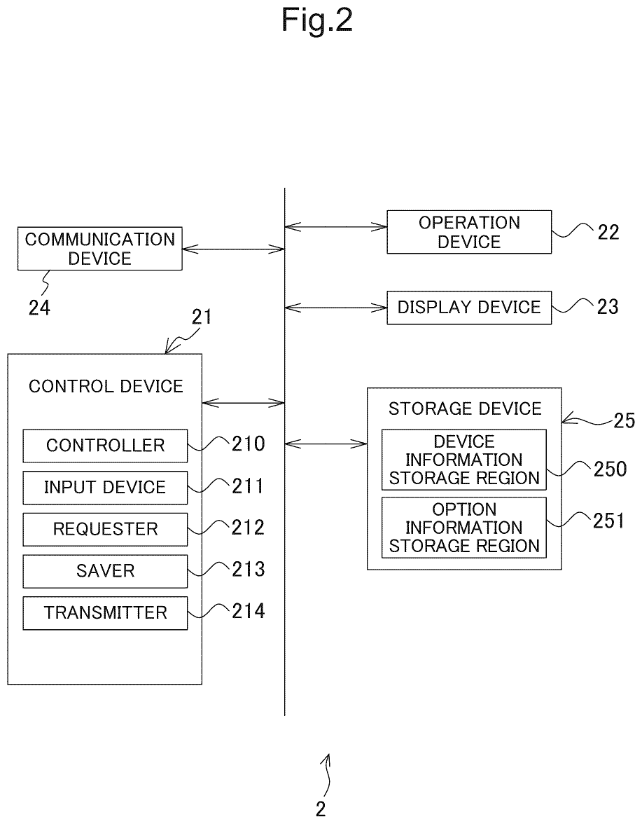

FIG. 2 is a functional block diagram schematically showing an essential internal configuration of the management device according to a first embodiment. The management device 2 includes a control device 21, an operation device 22, a display device 23, a communication device 24, and a storage device 25. The mentioned components are configured to transmit and receive data and signals to and from each other, via a communication bus.

The operation device 22 includes a keyboard and a mouse, for inputting commands or characters to the control device 21, and also operating a pointer on the screen of the display device 23. The operation device 22 receives, according to an operation made thereon by a user, an input of an instruction from the user. The display device 23 includes, for example, a liquid crystal display (LCD), and displays responses from the control device 21 and data results.

The communication device 24 makes communication with outside, through the network. The communication device 24 is a communication interface, for example, for transmitting and receiving various types of data, to and from external devices in the local area or on the internet, such as the image forming apparatus 1 and the license key issuing source 3.

The storage device 25 is a large-capacity storage device such as a hard disk drive (HDD) or a solid-state drive (SSD), and contains various control programs. In addition, the storage device 25 includes a device information storage region 250 and an option information storage region 251.

The device information storage region 250 is the region for storing the device information about the image forming apparatus 1 being managed by the management device 2. In the device information storage region 250, for example, identification information (serial number) for identifying the image forming apparatus 1, address information (IP address) indicating the address of the image forming apparatus 1, a log-in user name and a log-in password of a user authorized as the manager, are stored in association with one another, as the device information of the image forming apparatus 1, for example in the form of a file of an extensible markup language (XML) format.

The option information storage region 251 is the region for storing the license key, the type of the optional function corresponding to the license key, the image forming apparatus 1 (serial number) in which the license key is registered, and the expiry date of the license key, in association with one another, for example in the form of the file of the extensible markup language (XML) format. However, the saving method and the saving format of the device information and the license key information are not limited to the above.

The control device 21 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 21 includes a controller 210, an input device 211, a requester 212, a saver 213, and a transmitter 214.

To be more specific, the control device 21 acts as the controller 210, the input device 211, the requester 212, the saver 213, and the transmitter 214, when the processor operates according to the control program stored in the storage device 25. Here, the controller 210 and other components may be constituted in the form of a hardware circuit, instead of being realized by the operation of the control device 21 according to the control program. This also applies to other embodiments, unless otherwise specifically noted.

The controller 210 serves to control the overall operation of the management device 2. The controller 210 is connected to the operation device 22, the display device 23, the communication device 24, and the storage device 25, and controls the operation of the mentioned components.

The input device 211 receives the input of first information indicating the type of the optional function provided in the image forming apparatus 1, second information necessary for issuance of the license key for the optional function, third information indicating the address of the image forming apparatus 1, and fourth information necessary for logging in to the image forming apparatus 1. For example, the input device 211 receives the input of the mentioned information from the user, through the operation device 22.

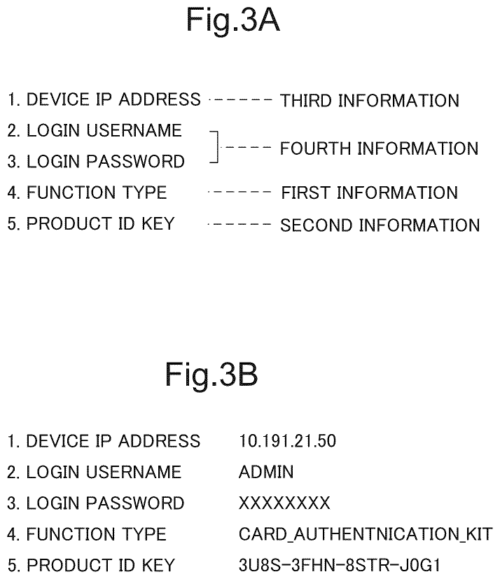

FIG. 3A illustrates an example of first to fourth information. A first item “Device IP address” is the information indicating the address of the image forming apparatus 1, and constituting the third information. A second item “Login username” is the information indicating the log-in user, and a third item “Login password” is the information indicating the log-in password, and the second and third items are constituting the fourth information. A fourth item “Function type” is the information indicating the optional function, and constituting the first information. A fifth item “Product ID key” is the information indicating the product ID key (serial number) of the optional function, and constituting the second information.

Here, since the serial number and the IP address of the image forming apparatus 1 are stored in the device information storage region 250 in association with each other, the input device 211 may receive the input of the serial number of the image forming apparatus 1, as the information indicating the address thereof, instead of the IP address.

FIG. 3B illustrates a specific example of each information shown in FIG. 3A. FIG. 3B shows that the address of the image forming apparatus 1 is “10.191.21.50”, that the log-in user name is “Admin”, that the log-in password is “XXXXXXXX”, that the type of the optional function is “CARD_AUTHENTICATION_KIT”, and that the product ID key of the optional function is “3U8S-3FHN-8STR-J0G1”.

The requester 212 transmits an instruction requesting to issue the license key, by transmitting the second information via the communication device 24, to the license key issuing source 3 that issues the license key for the optional function of the type indicated by the first information. For example, the requester 212 makes access to the website of the license key issuing source 3 that issues the license key for the optional function “card authentication kit”, and registers the product ID key in the website, thereby requesting to issue the license key.

Upon receipt of the mentioned registration, the license key issuing source 3 issues the license key. For example, the license key issuing source 3 transmits the license key and the information indicating the expiry date thereof, to the management device 2 through the network. The issuance and transmission of the license key by the license key issuing source 3 may be performed using a known technique.

The saver 213 saves the type of the optional function corresponding to the license key, the image forming apparatus 1 in which the license key is registered, and the expiry date of the license key in a predetermined storage region (e.g., storage region in the storage device 25), in association with one another.

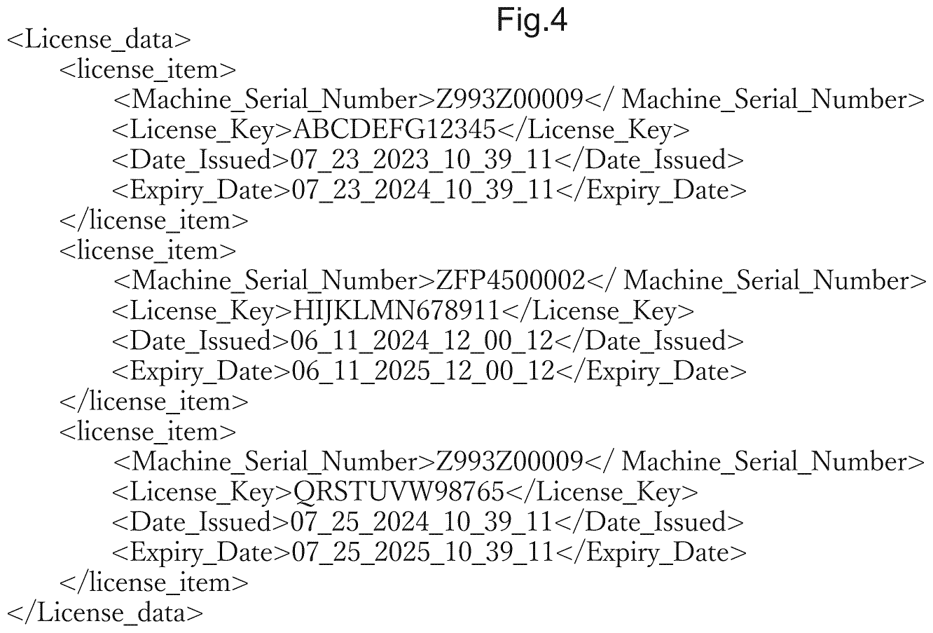

For example as shown in FIG. 4, the saver 213 saves, as the data of the license key for the optional function, the serial number of the image forming apparatus 1 (Machine_Serial_Number) in which the license key is registered, the license key (License_Key), the date on which the license key was issued (Date_Issued), and the expiry date of the license key (Expiry_Date), in association with one another, in the option information storage region 251, with respect to each of the optional functions.

The transmitter 214 logs in to the image forming apparatus 1 corresponding to the address indicated by the third information, by transmitting thereto the fourth information via the communication device 24, and transmits the license key, issued by the license key issuing source 3 in response to the request from the requester 212, to the image forming apparatus 1, to register the license key for the optional function of the type indicated by the first information, in the image forming apparatus 1.

For example, the transmitter 214 requests the image forming apparatus 1 to which the transmitter 214 has logged in, to register the license key for the optional function “card authentication kit”. The image forming apparatus 1 executes the registration of the license key for the optional function “card authentication kit”, in accordance with the request from the management device 2 (transmitter 214). To register the inputted license key in the image forming apparatus 1, a known technique may be employed. Thereafter, the controller of the image forming apparatus 1 (e.g., CPU) makes the optional function “card authentication kit” operate normally.

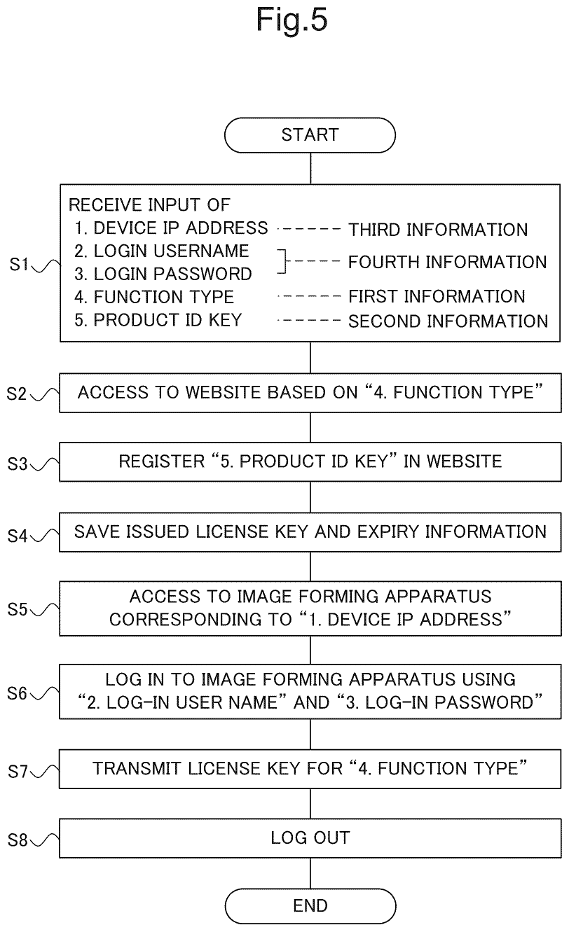

Referring to a flowchart shown in FIG. 5, an example of the process for the registration of the license key, executed by the management device 2, will be described hereunder.

When the input device 211 of the management device 2 receives the input of the first information (Function type) indicating the type of the optional function provided in the image forming apparatus 1, the second information (Product ID key) necessary for the issuance of the license key for the optional function, the third information (Device IP address) indicating the address of the image forming apparatus 1, and the fourth information (Log-in username, Log-in password) necessary for logging in to the image forming apparatus 1, made by the user through the operation device 22 (S1), the requester 212 makes access to the website of the predetermined license key issuing source 3, which is the issuer of the license key for the optional function of the image forming apparatus 1, of the type indicated by the first information (Function type) (S2).

Then the requester 212 transmits the product ID key on the basis of the second information, to the website via the communication device 24, thereby registering the product ID key in the website (S3). For the process of the registration of the product ID key by the license key issuing source 3, a known technique may be employed. Upon registering the product ID key, the license key issuing source 3 transmits the license key corresponding to the product ID key, and the information indicating the expiry date of the license key, to the management device 2 through the network.

Upon receipt of the license key and the information indicating the expiry date transmitted from the license key issuing source 3, via the communication device 24, the saver 213 saves the data of the license key in the option information storage region 251, as shown in FIG. 4 (S4).

Then the transmitter 214 makes access to the image forming apparatus 1 at the address indicated by the third information (Device IP address) via the communication device 24 (S5), and transmits the fourth information (Log-in username and Log-in password) (S6), thereby logging in to the image forming apparatus 1. The transmitter 214 transmits the license key, issued by the license key issuing source 3 in response to the request from the requester 212, and received via the communication device 24, to the image forming apparatus 1 via the communication device 24 (S7). The image forming apparatus 1 registers the received license key, in association with the optional function corresponding to the license key. The transmitter 214 then logs out from the image forming apparatus 1 (S8). At this point, the process is finished.

The arrangement according to this embodiment exempts the user from going to the location where the image forming apparatus 1 is installed, to register the license key therein, thereby alleviating the trouble imposed on the user for the issuance and the registration of the license key for the optional function provided in the image forming apparatus 1.

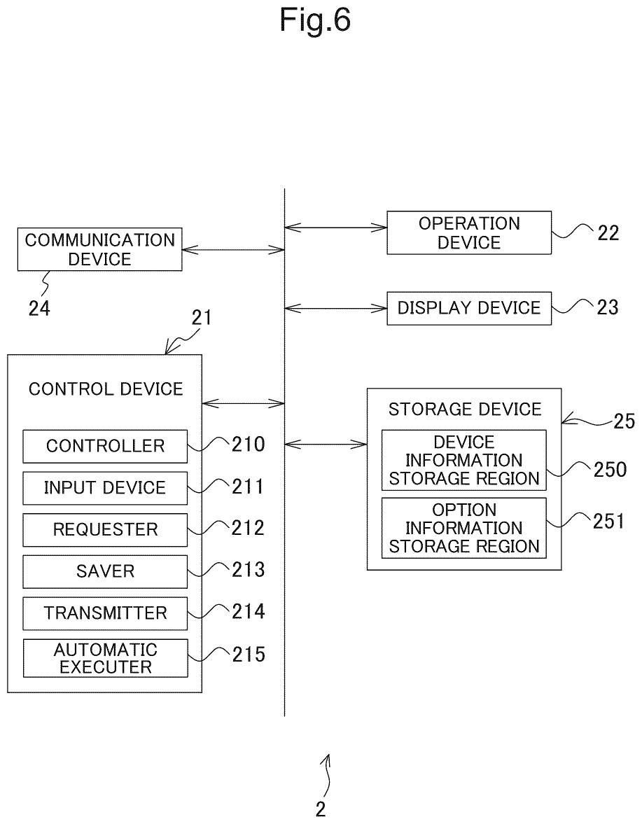

FIG. 6 is a functional block diagram schematically showing an essential internal configuration of the management device according to a second embodiment. The description of the same elements as those shown in FIG. 2 will not be repeated. In the management device 2 according to the second embodiment, the control device 21 acts as the controller 210, the input device 211, the requester 212, the saver 213, the transmitter 214, and further as an automatic executer 215, when the processor operates according to the control program stored in the storage device 25.

When the period before the expiry date of the license key stored in the option information storage region 251 becomes shorter than a predetermined first set value (e.g., 1 day), in other words when the expiry date comes close at hand, the automatic executer 215 identifies the image forming apparatus 1 having the optional function corresponding to the license key, the expiry date of which is close at hand, on the basis of the data stored in the option information storage region 251, and registers the license key using the causes the requester 212 and the transmitter 214, to update the license key, the expiry date of which is close at hand, registered in the image forming apparatus 1 identified as above. Through such arrangement, the optional function can be prevented from becoming unusable, because of the expiry of the license key.

For example, the automatic executer 215 looks up the option information storage region 251, thereby deciding whether the period before the expiry date of the license key is shorter than the first set value, and also identifies, by further looking up the option information storage region 251, the image forming apparatus 1 having the optional function, corresponding to the license key the expiry date of which is close at hand.

Then the requester 212 transmits the request to reissue the license key, to the predetermined license key issuing source 3, which is the issuer of the license key for the optional function of the type identified by the automatic executer 215, on the basis of the data stored in the device information storage region 250, by transmitting the second information via the communication device 24. The transmitter 214 identifies the image forming apparatus 1, in which the original license key of the reissued license key is registered, on the basis of the data stored in the device information storage region 250, and logs in to the identified image forming apparatus 1, by transmitting thereto the fourth information of the license key via the communication device 24. Then the transmitter 214 receives the reissued license key from the management device 2, and transmits the reissued license key to the image forming apparatus 1 identified as above. In the image forming apparatus 1, as result, the license key thus far utilized is updated to the reissued license key.

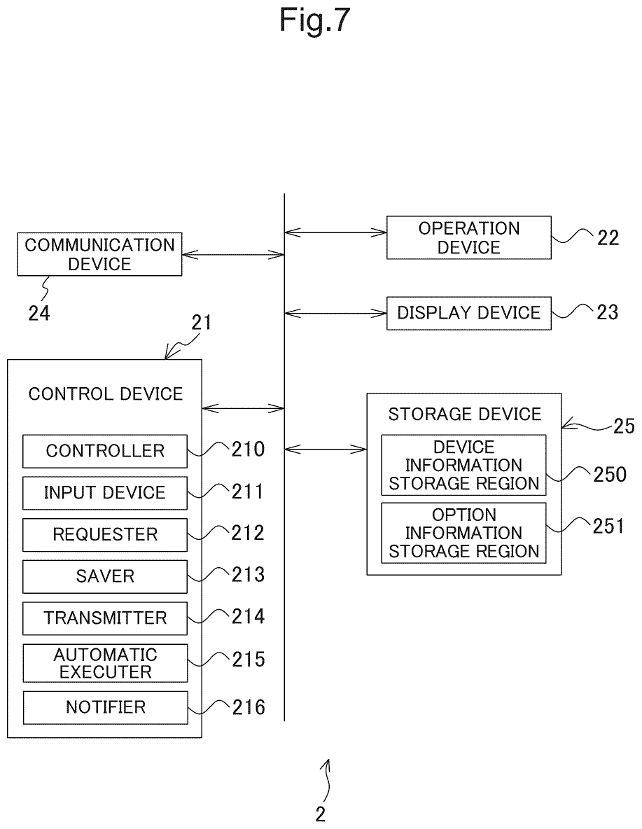

FIG. 7 is a functional block diagram schematically showing an essential internal configuration of the management device according to a third embodiment. The description of the same elements as those shown in FIG. 6 will not be repeated. In the management device 2 according to the third embodiment, the control device 21 acts as the controller 210, the input device 211, the requester 212, the saver 213, the transmitter 214, the automatic executer 215, and further as a notifier 216, when the processor operates according to the control program stored in the storage device 25.

When the period before the expiry date of the license key becomes shorter than a predetermined second set value (e.g., 30 days), in other words when the expiry date comes close, the automatic executer 215 identifies the type of the optional function corresponding to the license key, the expiry date of which is close, and the image forming apparatus 1 in which the license key is registered, on the basis of the data stored in the option information storage region 251.

The notifier 216 notifies the image forming apparatus 1 and the type of the optional function, corresponding to the license key the expiry date of which is close, identified by the automatic executer 215, to the user. For example, the notifier 216 causes the display device 23 to display a message indicating the image forming apparatus 1 and the type of the optional function, corresponding to the license key the expiry date of which is close, identified as above. Such arrangement prevents the user from forgetting to execute the updating operation of the license key.

For example, the notifier 216 looks up the option information storage region 251, thereby deciding whether the period before the expiry date of the license key is shorter than the second set value, and also identifies, by further looking up the option information storage region 251, the image forming apparatus 1 having the optional function, corresponding to the license key the expiry date of which is close.

In the case of the existing management device, the user may have to perform the operation to acquire the license key, and also the operation to register the license key in the image forming apparatus, in order to make the optional function operate normally. Besides, the user has to move to the location where the image forming apparatus is installed, to register the license key in the image forming apparatus.

However, a large number of image forming apparatuses are often installed, in companies or plants. Acquiring the license key for each of the image forming apparatuses, and registering the license key in each single image forming apparatus, constitute a heavy burden on the user. Although a technique to transfer the license key is known, such a technique is not designed to alleviate the trouble of the user in acquiring and registering the license key.

In contrast, the arrangement according to the foregoing embodiment can alleviate the trouble of the user, in acquiring and registering the license key for the optional function provided in the image forming apparatus.

The disclosure may be modified in various manners, without limitation to the foregoing embodiment. Further, the configurations and processings according to the embodiment, described with reference to FIG. 1 to FIG. 7, are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is;

1. A management device configured to manage a plurality of image forming apparatuses through a network, the management device comprising:
a communication device that makes communication with outside, through the network;
an input device that receives an input of first information indicating a type of an optional function provided in the image forming apparatus, second information necessary for issuing a license key for the optional function, third information indicating an address of the image forming apparatus, and fourth information necessary for logging in to the image forming apparatus;
a requester that transmits an instruction requesting to issue the license key, by transmitting the second information via the communication device, to a predetermined license key issuing source that issues the license key for the optional function of the type indicated by the first information; and
a transmitter that logs in to the image forming apparatus corresponding to the address indicated by the third information, by transmitting the fourth information via the communication device, and transmits the license key, received from the license key issuing source in response to the instruction of the requester, to the image forming apparatus.

2. The management device according to claim 1, further comprising:
a saver that saves, when an expiry date is specified in the license key, issued by the license key issuing source in response to the instruction from the requester, the license key, the type of the optional function corresponding to the license key, the image forming apparatus in which the license key is registered, and the expiry date of the license key, in a predetermined storage region, in association with one another; and
an automatic executer that identifies, when a period before the expiry date of the license key becomes shorter than a predetermined first set value, the type of the optional function corresponding to the license key, on a basis of data stored by the saver,
wherein the requester transmits an instruction requesting to reissue the license key, by transmitting the second information via the communication device, to the license key issuing source that issues the license key for the optional function of the type identified by the automatic executer, and
the transmitter logs in, by transmitting the fourth information of the license key via the communication device, to the image forming apparatus in which the license key stored by the saver is to be registered, receives the license key reissued by the license key issuing source in response to the instruction from the requester, and transmits the reissued license key to the image forming apparatus.

3. The management device according to claim 1, further comprising:
a saver that saves, when an expiry date is specified in the license key, issued by the license key issuing source in response to the instruction from the requester, the type of the optional function corresponding to the license key, the image forming apparatus in which the license key is registered, and the expiry date of the license key, in a predetermined storage region, in association with one another;
an automatic executer that identifies, when a period before the expiry date of the license key becomes shorter than a predetermined second set value, the type of the optional function corresponding to the license key, and the image forming apparatus in which the license key is registered, on a basis of data stored by the saver; and
a notifier that notifies the image forming apparatus and the type of the optional function, corresponding to the license key the expiry date of which is close, identified by the automatic executer, to the user.

4. The management device according to claim 3, further comprising a display device,
wherein the notifier causes the display device to display a message indicating the image forming apparatus and the type of the optional function, corresponding to the license key the expiry date of which is close, identified by the automatic executer.
